(19) United States
(12) Patent Application Publication
(10) Pub. No.: US 2015/0198569 A1
(43) Pub. Date: Jul. 16, 2015

(54) MASS ANALYSIS METHOD AND MASS ANALYSIS SYSTEM

(71) Applicant: Hitachi High-Technologies Corporation, Minato-ku, Tokyo (JP)

(72) Inventors: Noriko Baba, Tokyo (JP); Shinji Yoshioka, Tokyo (JP); Hiroyuki Yasuda, Tokyo (JP)

(21) Appl. No.: 14/413,603

(22) PCT Filed: Jul. 8, 2013
(86) PCT No.: PCT/JP2013/068585

§ 371 Date: Jan. 8, 2015

(30) Foreign Application Priority Data
Jul. 24, 2012 (JP) 2012-163220

(51) Int. Cl. G01N 30/72; H01J 49/00; G01N 30/86

(52) U.S. Cl. CPC G01N 30/7233; G01N 30/8634; H01J 49/0027

(57) ABSTRACT

Provided is a mass analysis method that prevents quantitative precision from decreasing. This mass analysis method uses an analysis system including a mass analysis device and a subdetector connected to each other, the subdetector displaying intensity and detection time relating to constituents of a sample at a preceding stage of the mass analysis device, the method comprising: (a) after injection of a sample, analyzing the sample with an analyzing apparatus including the subdetector, and after the sample has passed through the subdetector, injecting the sample into the mass analysis device; (b) acquiring data from both the subdetector and the mass analysis device; and (c) determining which of peaks that the subdetector and the mass analysis device have detected is to be analyzed, based on whether overlapping peaks are present and whether the same peak between data from the subdetector and the mass analysis device is present.

### TECHNICAL FIELD

The present invention relates to those mass analysis methods and mass analysis systems that use a mass analysis device and a subdetector provided at a preceding stage of the mass analysis device.

### BACKGROUND ART

Patent Document 1 discloses a “liquid chromatograph mass spectrometer including a mass spectrometer as a main detector, and a subdetector provided separately from the mass spectrometer, with a flow channel being constructed so that a sample from a liquid chromatograph unit enters the subdetector first and then, after a predetermined time, the sample enters the mass spectrometer”.

### PRIOR ART LITERATURE

### Patent Documents

Patent Document 1: JP-2002-181784-A

### SUMMARY OF THE INVENTION

### Problems to be Solved by the Invention

During quantitative analysis with a mass spectrometric device where a sample includes a large number of constituents, a plurality of detected peaks are overlapped each other, resulting in reducing the number of data points relating to target constituents. During the quantitative analysis, the reduction in the number of data points making up a chromatogram may affect precision and reproducibility of the chromatogram, thus significantly reducing quantitative precision.

### Means for Solving the Problem

The present invention determines which of peaks that have been detected by a subdetector and a mass analysis device is to be analyzed, from whether overlapping peaks are present and whether the same peak between data from the subdetector and the mass analysis device is present.

### Effects of the Invention

A mass analysis method and mass analysis system according to an aspect of the present invention can prevent quantitative precision from decreasing.

### BRIEF DESCRIPTION OF THE DRAWINGS

FIG. 1 is a device configuration diagram of the present invention.

FIG. 2 is a block diagram of control functions according to an embodiment of the present invention.

FIG. 3 is an operation flowchart of the present invention.

FIG. 4 is a diagram that, shows examples of display of chromatograms acquired by device's that are constituent elements of the embodiment.

FIG. 5 is a diagram that shows example of extracted chromatogram information computed in data analyzing block.

FIG. 6 is a diagram that shows exemplary methods of peak determination with a data processing unit.

### MODE FOR CARRYING OUT THE INVENTION

Hereunder, operation of data processing according to an embodiment of the present invention will be described in accordance with the accompanying drawings.

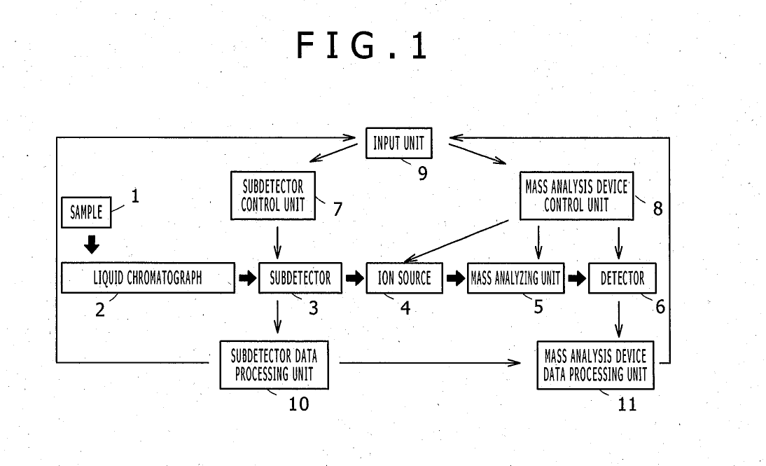

FIG. 1 shows a device configuration of a mass analysis system used in the embodiment of the present invention.

As shown in FIG. 1, the mass analysis system used in the present embodiment includes: a chromatograph 2 intended to separate a sample 1; a subdetector 3 prepared separately from a mass analysis device; an ion source 4 that ionizes the sample that the subdetector 3 has analyzed; a mass analyzing unit 5 that analyzes a mass of the ions which have been introduced from the ion source 4; a detection unit 6 that detects the ions; a subdetector control unit 7 that controls the subdetector 3; a mass analysis device control unit 8 that controls the mass analysis device; an input unit 9 used to enter analytical methods to be transmitted to the control units; a data processing unit 10 that processes data acquired by the subdetector 3; and data processing unit 11 that processes data acquired by the mass analysis device.

In addition, the mass analysis device according to the present embodiment includes the ion source 4, the mass analyzing unit 5, and the detection unit 6.

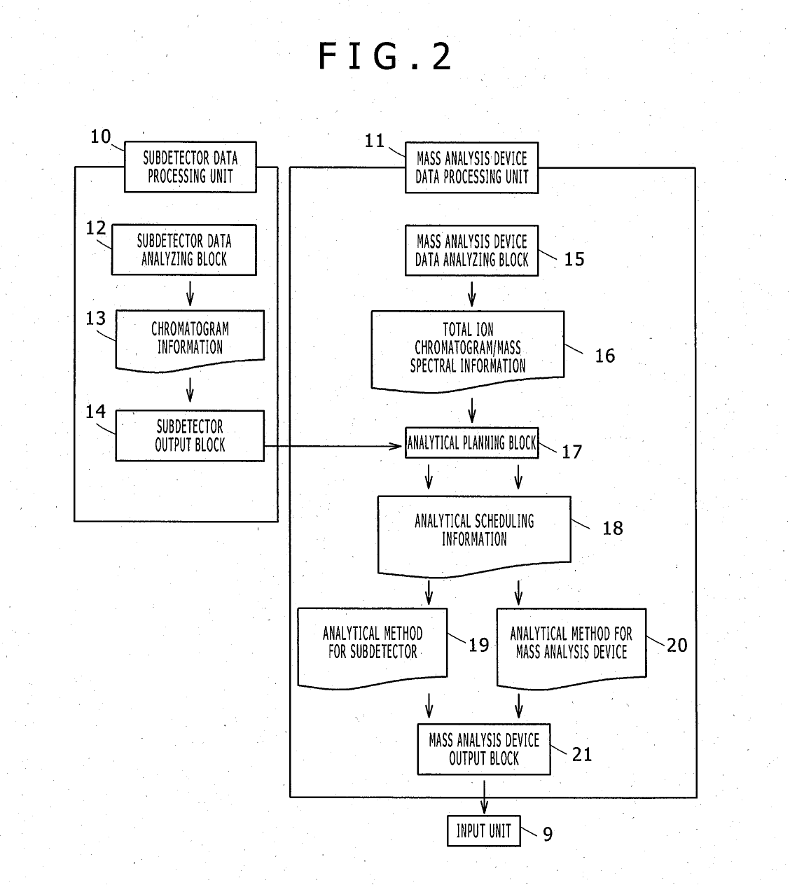

A block diagram of control functions according to an embodiment of the present invention is shown in FIG. 2.

The subdetector data processing unit 10 and the mass analysis device data processing unit 11 shown in FIG. 1 include following functions. In FIG. 2, the same reference numbers as used in FIG. 1 denote the same functional elements.

The subdetector data processing unit 10 includes a subdetector data analyzing block 12 that analyzes data obtained by the subdetector 3, and a subdetector output block 14 configured to output chromatogram information 13 to the mass analysis device data processing unit, and to display independent data obtained by the subdetector 3.

The mass analysis device data processing unit 11 of the mass analysis device includes: a data analyzing block 15 of the mass analysis device; total ion chromatogram/mass spectral information 16; an analysis planning block 17 that generates analytical methods; analytical scheduling information 18 that the analytical planning block 17 has generated by comparing the subdetector data and the mass analysis device data; a subdetector analytical method 19 that has been generated for the subdetector 3 from the analytical scheduling information 18; a mass analysis device analytical method 20 that has been generated for the mass analysis device; and a mass analysis device output block 21 configured to display the generated analytical methods and to output these analytical methods.

After acquiring data from the subdetector 3, the subdetector data processing unit 10 transmits this acquired data from the subdetector output block 14 to the analytical planning block of the mass analysis device data processing unit 11 of the mass analysis device in order to compare the data against the data acquired by the mass analysis device. The analytical planning block 17 of the mass analysis, device compares the chromatogram information 13 and the total ion chromatogram/mass spectral information 16 and then generates comparison results that serve as the analytical scheduling information 18. The subdetector analytical method 19 and mass analysis device analytical method 20 to be used for the devices (the device with the subdetector, and the mass analysis device) are then generated from the comparison results, and after this, the analytical methods are transmitted from the mass analysis device output block 21 to the input unit 9 that transmits instructions to the control units for the devices.

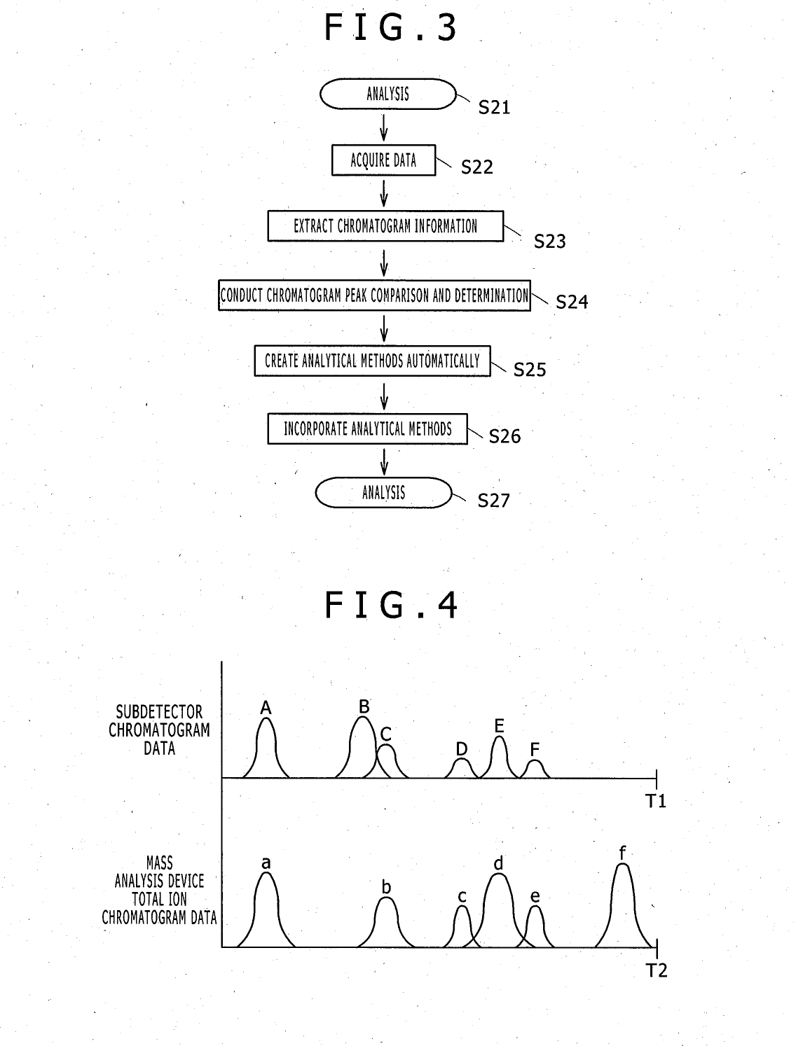

A flowchart of the present invention is shown in FIG. 3.

The system including the mass analysis device and the subdetector 3 connected to the liquid chromatograph 2 starts an analytical process (step S21), and then the device with the subdetector 3, and the mass analysis device each acquire data independently (step S22). After this, the data processing units 10, 11 of the devices extract chromatogram information (step S23) and then use this extracted chromatogram information to compare and determine the chromatogram peaks (step S24). Next, based on results of these comaprison and determination, the subdetector analytical method 19 for the subdetector, and the mass analysis divide analytical method 20 for the mass analysis device are created automatically (step S25). The analytical methods 19, 20 are then incorporated into the devices (step S26), and the analytical process is resumed (step S27).

Examples of data acquired in data acquisition step S22 shown in the flowchart of FIG. 3 relating to the present invention are shown in FIG. 4.

Chromatogram data that the subdetector 3 has acquired is displayed in an upper row, and a total ion chromatogram that the mass analysis device has acquired is displayed in a lower row. In the data acquired by the subdetector 3, a peak top of a first peak detected after measurement has been started is expressed as A, and other peaks subsequently detected are expressed as B, C, and D, in order of the detection. In addition, a time from a start of analysis with the subdetector 3 to an end of the analysis is expressed as T1. Similarly, of all peaks acquired by the mass analysis device, only a peak top first peak detected after measurement has been started is expressed as “a”, and other peaks subsequently detected are expressed as “b”, “c”, and “d”. A time from a start of analysis with the mass analysis device to an end of the analysis is expressed as T2.

Referring to FIG. 4, if the data acquired by the subdetector 3 is data acquired using a photodiode array (PDA) detector or any other detector that displays data in a three-dimensional format (time, wavelength, and intensity), data on all constituents detected at intensities exceeding a previously set threshold level will be converted into one chromatogram without limitation to specific wavelengths and correspondingly displayed.

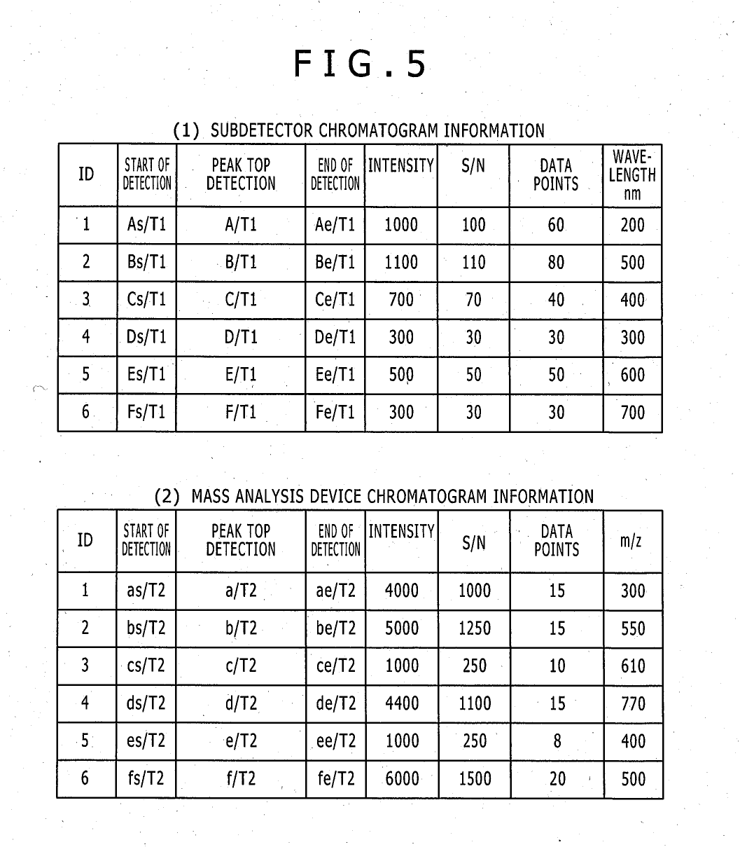

Examples of chromatogram information extracted in the chromatogram extraction step of FIG. 3 are shown in FIG. 5.

The chromatogram information extracted from the data that the subdetector 3 has acquired is shown in an upper half (1) of FIG. 5. An ID, a peak detection starting time, a peak top detection time, a peak detection ending time, peak intensity, a peak S/N ratio; the number of peak data points, and peak detection wavelength are extracted for one detected peak in the chromatogram. It is assumed here that the first peak detected after the analysis has been started is A. In this case, a rate of As, the time when the detection of peak A was started, to the analytical time T1, is expressed in terms of As/T1. Similarly, a rate of the detection time of the peak top A to T1 is expressed in terms of A/T1 and a rate of the peak detection ending time Ae to T1 is expressed in terms of Ae/T1.

The chromatogram information extracted from the data that the mass analysis device has acquired is shown in a lower half (2) of FIG. 5. As in a case of the chromatogram information acquired by the subdetector 3, an ID, a peak detection starting time, a peak top detection time, a peak detection ending time, peak intensity, a peak S/N ratio, the number of peak data points, and a peak component mass-charge (m/z) ratio are extracted for one detected peak in the chromatogram.

If the subdetector 3 does not support wavelength detection, display items relating to the constituent detection method characterizing the subdetector 3 are added to the chromatogram information shown in FIG. 5.

A condition for conducting determinations as to each peak is defined on the basis of the chromatogram information shown in FIG. 5. It is to be understood that overlapping peaks in the present invention refer, to the same peaks whose detection ending time is determined, within a set range, to agree with the detection starting time of a peak immediately following that peak. This agreement is described in detail below using the chromatograms of FIG. 4 and the chromatogram information of FIG. 5. Peaks B and C in the chromatogram created by the subdetector 3 can be taken to mean overlapping peaks when the detection ending time Be/T1 of peak B and the detection starting time Cs/T1 of peak C adjoining peak B are in a relationship of “Be/T1≦Cs/T1”. This relational expression, however, assumes that there is a set range in which a time corresponding to intensity minus an intensity level of a noise peak, calculated before the peak was detected, and a time corresponding to intensity minus an intensity level of a noise peak calculated after the peak has been detected are taken as the detection starting time and the detection ending time, respectively.

It is to be understood that the same peaks in the present invention refer to peaks for which, between the two sets of data acquired by the devices, the detection time (A/T1) of the peak top is determined, within the set range, to be a peak derived from the same constituent. This determination is described in detail below using the chromatograms of FIG. 4 and the chromatogram information of FIG. 5. It is to be understood that when the detection time A/T1 of the peak top in the subdetector chromatogram of FIG. 4 and the detection time a/T2 of the peak top in the mass analysis device chromatogram are in a relationship of “A/T1=a/T2”, peak A and peak “a” are the same peaks. This description, however, assumes that these peaks are present within the set range of time ratios.

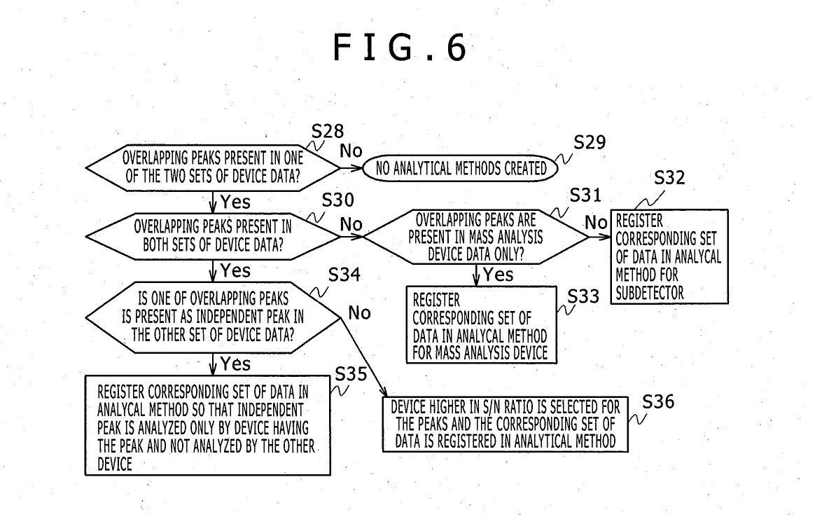

Chromatogram peak comparing and determining step S24 in FIG. 3 is described in further detail below referring to a flowchart of FIG. 6.

In the present invention, when overlapping peaks are present, which of the two devices (the subdetector 3 and the mass analysis device) is to be used to analyze the peaks again is determined and an optimum analytical method is generated. A condition for conducting the determination is described below.

In the step of determining whether overlapping peaks are present in one of the two sets of data acquired in the devices (step S28), if no peaks are overlapping, re-measurement does not take place and analytical methods are not created (step S29). If overlapping peaks are present, whether the overlapping peaks are present in both sets of device data is additionally determined (step S30). If the overlapping peaks are not present in both sets of device data, whether the overlapping peaks are present in the mass analysis device data only is further determined (step S31). If the overlapping peaks are present in the subdetector 3 only, the corresponding set of data is registered in the analytical method 19 for the subdetector (step S32). If the overlapping peaks are present in the mass analysis device only, the corresponding set of data is registered in the analytical method 20 for the mass analysis device (step S33).

If the overlapping peaks are determined to be present in both devices (step S30), it is further determined whether one of the overlapping peaks is present as an independent peak in the other set of device data (step S34). If one of the overlapping peaks is not present as an independent peak in the other set of device data (step S36), that is, if the overlapping peaks are present as independent peaks in both devices, the device higher in S/N ratio is selected for the overlapping peaks and the corresponding set of data is registered in the analytical method (step S36). If one of the overlapping peaks is present as an independent peak in the other set of device data, the corresponding set of data is registered in the analytical method so that only the device in which the independent peak is present analyzes the independent peak and the other device does not analyze the independent peak (step S35).

Determination steps S34, S35 in the flowchart of FIG. 6 are described in further detail below referring to the chromatograms of FIG. 4.

If one of the overlapping peaks is present as an independent peak in the other set of device data (step S34), this means that of peaks B and C that the subdetector 3 has determined to be overlapping peaks, peak C has been determined to be the same as peak “b” present in the mass analysis device chromatogram. In this case, the corresponding set of device data is registered in the analytical method so that only the mass analysis device analyzes the independent peak, or peak “b”, that is present in the mass analysis device, and so that the subdetector 3 does not analyze peak C present in the subdetector (step S35).

In the present invention, independent peaks refer to peaks not overlapping in one set of device data. Referring to the chromatograms shown in FIG. 4, the independent peaks refer to peaks A, “a”, “b”, and “f”, that is, the peaks for which the relational expression for overlapping peaks does not hold.

The subdetector 3 used in the present invention would be an ultraviolet-light detector (UV detector), a visible-light detector (VIS detector), a photodiode array detector (PDA detector), a refractive index detector (RI detector), a fluorescent-light detector (FL detector), charged-aerosol detector (CAD), or the like. The subdetector can however be replaced by any device including a detector which is both connectible to the liquid chromatograph and capable of displaying chromatogram data.

In the present invention, either of the two devices can be set so as to acquire data, thereby allowing the overlapping of peaks to be avoided and thus the number of peak data points to be increased and quantitative precision to be enhanced.

To increase the number of points in data to be acquired, it is necessary to broaden chromatogram peaks or to raise sensitivity, both of which are liable to extend the analytical time or reduce intensity of target ions.In the present invention, however, overlapping peaks are continuously detected by using the plurality of detectors, which causes little influence in terms of the extension of the analytical time or the reduction in the intensity of target ions.

Repeated use of the same analytical method is needed where a component to be analyzed is the same between samples, as in quantitative analysis of blood components. The use of the present invention, however, allows reduction in a user's workload of creating the analytical method. This is because, since the'invention improves quantitative precision and reproducibility, reliability of data increases and this alleviates complicatedness of the creation of the method due to repeated analysis of the data.

### DESCRIPTION OF REFERENCE NUMBERS

1: Sample
2: Liquid chromatograph
3: Subdetector
4: Ion source
5: Mass analyzing unit
6: Detection unit
7: Subdetector control unit
8: Mass analysis device control unit
9: Input unit
10: Subdetector data processing unit
11: Mass analysis device data processing unit
12: Subdetector data analyzing block
13: Chromatogram information
14: Subdetector output block
15: Mass analysis device data analyzing block
16: Total ion chromatogram/mass spectral information
17: Analytical planning block
18: Analytical scheduling information
19: Analytical method for subdetector
20: Analytical method for mass analysis device
21: Mass analysis device output block

1. A mass analysis method that uses an analysis system including a mass analysis device and a subdetector connected to each other, the subdetector displaying intensity and detection time relating to constituents of a sample at a preceding stage of the mass analysis device, the method comprising:
(a) after injection of a sample, analyzing the sample with an analyzing apparatus including the subdetector, after the sample has passed through the subdetector, injecting the sample into the mass analysis device, and analyzing the sample with the mass analysis device;
(b) acquiring data from both the subdetector and the mass analysis device; and
(c) determining which of peaks that the subdetector and the mass analysis device have detected is to be analyzed, based on whether overlapping peaks are present and whether the same peak between data from the subdetector and the mass analysis device is present.

2. The mass analysis method according to claim 1, further comprising:
calculating a detection time for a peak top in each of chromatograms, and a ratio of a detection time for the peak top in each of the chromatograms with respect to a total analytical time.

3. The mass analysis method according to claim 1, further comprising:
calculating, in each of the subdetector and the mass analysis device, a detection starting time for each of chromatograms, a detection ending time for each of the chromatograms, a ratio of the detection starting time with respect to a total analytical time, and a ratio of the detection ending time with respect to the total analytical time.

4. The mass analysis method according to claim 1, further comprising:
extracting, in the subdetector and the mass analysis device, the number of data points in each of peaks in each of different sets of chromatogram data, and a signal to-noise ratio (S/N ratio) for each of the peaks.

5. The mass analysis method according to claim 1, further comprising:
comparing detected chromatogram peaks between the subdetector and the mass analysis device, and determining from comparison results whether the peaks are derived from the same constituent.

6. The mass analysis method according to claim 2, further comprising:
determining, from the ratio of the detection time for the peak top in each of the chromatograms with respect to the total analytical time, whether the same peak between data from the subdetector and the mass analysis device is present.

7. The mass analysis method according to claim 3, further comprising:
between succeeding chromatogram peaks, comparing the detection ending time of an earlier chromatogram peak and the detection starting time of a later chromatogram peak; and
if the earlier peak's detection ending time is later than the later peak's detection starting time, determining that the peaks are overlapped.

8. The mass analysis method according to any one of claims 1 to 7, further comprising:
if an overlapping peak is found in data from the subdetector or the mass analysis device, determining whether a corresponding peak as an independent peak is present in data from the other device; and
if a corresponding peak as an independent peak is present, analyzing this peak by using the data from the other device.

9. The mass analysis method according to any one of claims 1 to 7, further comprising:
if an overlapping peak is found in data from the subdetector or the mass analysis device, determining whether a corresponding peak as an independent peak is present in data from the other device; and
if a corresponding peak as an independent peak is not present, analyzing this peak by using the data in which the signal-to-noise ratio (S/N ratio) is higher.

10. A mass analysis system comprising:
a mass analysis device that displays ion data in terms of m/z, intensity, and detection time, as chromatogram data; and
a subdetector connected to the mass analysis device, the subdetector displaying intensity and detection time relating to constituents of a sample, as chromatogram data, at a preceding stage of the mass analysis device;
wherein:
(a) after injection of a sample, analyzing the sample with an analyzing apparatus including the subdetector, after the sample has passed through the subdetector, injecting the sample into the mass analysis device, and analyzing the sample with the mass analysis device;
(b) acquiring data from both the subdetector and the mass analysis device; and
(c) determining which of peaks that the subdetector and the mass analysis device have detected is to be analyzed, based on whether overlapping peaks are present and whether the same peak between data from the subdetector and the mass analysis device is present.

11. The mass analysis system according to claim 9, wherein:
if an overlapping peak is found in data from the subdetector or the mass analysis device, determining whether a corresponding peak as an independent peak is present in data from the other device; and
if a corresponding peak as an independent peak is present, analyzing this peak by using the data from the other device.

12. The mass analysis system according to claim 9, wherein:
if an overlapping peak is found in data from the subdetector or the mass analysis device, determining whether a corresponding peak as an independent peak is present in data from the other device; and
if a corresponding peak as an independent peak is not present, analyzing this peak by using the data in which the signal-to-noise ratio (S/N ratio) is higher.
